(19) United States
(12) Patent Application Publication
(10) Pub. No.: US 2017/0113222 A1
(43) Pub. Date: Apr. 27, 2017

(54) PARTICLE MANIPULATION SYSTEM WITH SPIRAL FOCUSING CHANNEL

(71) Applicant: Owl biomedical, Inc., Goleta, CA (US)

(72) Inventors: Daryl W. Grummitt, Santa Barbara, CA (US); Mehran R. Hoonejani, Goleta, CA (US)

(73) Assignee: Owl biomedical, Inc.

(21) Appl. No.: 14/919,786

(22) Filed: Oct. 22, 2015

(51) Int. Cl. B01L 3/00

(52) U.S. Cl. CPC B01L 3/502761; B01L 2300/0627; B01L 2200/0652; B01L 2200/0636; B01L 2300/0832; B01L 2400/0487

(57) ABSTRACT

A particle manipulation system uses a spiral focusing channel to focus particles into a distribution near the centerline of the flow. The spiral focusing channel may have first portion and a second portion, wherein the first portion has a uniform cross section and curves in an arc of at least about 180 degrees, and the second portion has undulating sidewalls resulting in a varying cross section. The first portion may focus the particles substantially in a plane, and the second portion may focus the particles in a dimension orthogonal to the plane.

### CROSS REFERENCE TO RELATED APPLICATIONS

Not applicable.

### STATEMENT REGARDING FEDERALLY SPONSORED RESEARCH

Not applicable.

### STATEMENT REGARDING MICROFICHE APPENDIX

Not applicable.

### BACKGROUND

This invention relates to a system and method for manipulating small particles in a microfabricated fluid channel.

Microelectromechanical systems (MEMS) are very small, often moveable structures made on a substrate using surface or bulk lithographic processing techniques, such as those used to manufacture semiconductor devices. MEMS devices may be moveable actuators, sensors, valves, pistons, or switches, for example, with characteristic dimensions of a few microns to hundreds of microns or more. A moveable MEMS switch, for example, may be used to connect one or more input terminals to one or more output terminals, all microfabricated on a substrate. The actuation means for the moveable switch may be thermal, piezoelectric, electrostatic, or magnetic, for example. MEMS devices may also be fabricated on a semiconductor substrate which may manipulate particles passing by the MEMS device in a fluid stream.

Accordingly, a MEMS device may be a movable valve, used as a sorting mechanism for sorting various particles from the fluid stream, such as cells from blood. The particles may be transported to the sorting device within the fluid stream enclosed in a microchannel, which flows under pressure. Upon reaching the MEMS sorting device, the sorting device may direct the particles of interest such as a blood stem cell, to a separate receptacle, and may direct the remainder of the fluid stream to a waste receptacle.

MEMS-based cell sorter systems may have substantial advantages over existing fluorescence-activated cell sorting systems (FACS) known as flow cytometers. Flow cytometers are generally large and expensive systems which sort cells based on a fluorescence signal from a tag affixed to the cell of interest. The cells are diluted and suspended in a sheath fluid, and then separated into individual droplets via rapid decompression through a nozzle. After ejection from a nozzle, the droplets are separated into different bins electrostatically, based on the fluorescence signal from the tag. Among the issues with these systems are cell damage or loss of functionality due to the decompression, difficult and costly sterilization procedures between samples, inability to re-sort sub-populations along different parameters, and substantial training necessary to own, operate and maintain these large, expensive pieces of equipment. For at least these reasons, use of flow cytometers has been restricted to large hospitals and laboratories and the technology has not been accessible to smaller entities.

A number of patents have been granted which are directed to the much smaller, MEMS-based particle sorting devices. For example, U.S. Pat. No. 6,838,056 (the '056 patent) is directed to a MEMS-based cell sorting device, U.S. Pat. No. 7,264,972 b1 (the '972 patent) is directed to a micromechanical actuator for a MEMS-based cell sorting device. U.S. Pat. No. 7,220,594 (the '594 patent) is directed to optical structures fabricated with a MEMS cell sorting apparatus, and U.S. Pat. No. 7,229,838 (the '838 patent) is directed to an actuation mechanism for operating a MEMS-based particle sorting system. Additionally, U.S. patent application Ser. No. 13/374,899 (the '899 application) and Ser. No. 13/374,898 (the '898 application) provide further details of other MEMS designs. Each of these patents ('056, '972, '594 and '838) and patent applications ('898 and '899) is hereby incorporated by reference.

In each of these systems, the precision with which one can sort a target particle from non-target material may depend in part on the precision with which one knows the speed of the particles flowing through the channels. If the speed is faster than expected, the gate or valve may open too late, if the speed is slower the valve or gate may open too early. As is well known from fluid mechanics, the velocity of a fluid flowing through a channel or pipe depends on its location within the pipe, moving more slowly against the walls of the pipe or channel than in the center. Accordingly, there is a velocity profile that depends on the distance from the center of the pipe.

In the channels made using microfabrication techniques, dimensions are such that hydrodynamic forces may come into play which make possible particle focusing within the small channels. Hydrodynamic particle focusing techniques have been taught by, for example, “Single-layer planar on-chip flow cytometer using microfluidic drifting based three-dimensional (3D) hydrodynamic focusing,” by Xaiole Mao, et al. (hereinafter “Mao,” Journal of Royal Society of Chemistry, Lab Chip, 2009, 9, 1583-1589). However, these techniques have generally been limited to focusing in one or two dimensions, and without complete effectiveness. Accordingly, an ongoing problem is the measurement of flow speeds accurately and assurance of velocity uniformity within the channel.

### SUMMARY

One feature of the MEMS-based microfabricated particle sorting system is that the fluid may be confined to small, microfabricated channels formed in a semiconductor substrate, throughout the sorting process. Because the channels are microfabricated, their dimensions may be quite small, on the order of microns for example. Within these narrow channels, fluid forces, shear, and viscoelasticitic effects can be considerable.

As described below, curved microfluidic channels may be constructed wherein Dean forces are large enough to focus particles substantially in a plane. In addition, complex shapes of microfluidic channels may be formed in the substrate surface, and careful selection of these shapes may result in particle focusing in the other dimensions. The complex shapes are easily achieved using photolithography through a mask to form the channel shapes on the substrate surface. The particle focusing structures may then be coupled with a microfabricated particle manipulation device, which may also be formed lithographically in the substrate surface.

The system described herein is a particle manipulating structure which may make use of the microchannel architecture of a MEMS particle manipulation device. More particularly, the systems and methods may be a particle manipulation structure with a spiral inlet channel, a particle manipulation device, and at least one output channel. The spiral focusing channel may have a first portion and a second portion, wherein the first portion has uniform cross section and focuses the particles in a plane, and the second portion has undulating sidewalls resulting in a varying cross section, and focuses the particles in the orthogonal dimension.

Therefore, the spiral focusing channel may focus the particles suspended in the carrier fluid or buffer fluid into a streamline near the center of the channel. Both the particle manipulation device and the spiral focusing channel may be formed in the surface of a substrate using MEMS fabrication techniques. This architecture has some significant advantages relative to the prior art, and is described further below.

Accordingly, a micromechanical particle manipulation structure is described, which may include a sample fluid having target particles in an initial distribution along with non-target material, in an input channel formed on a substrate, a particle manipulation device formed on a substrate that manipulates the sample fluid flowing in the input channel, and a spiral focusing channel microfabricated in the substrate and disposed upstream of the particle manipulation device, wherein the spiral focusing channel is curved in a spiral shape having a first portion with substantially uniform cross section which focuses the particles toward a plane parallel to the substrate, and a second portion downstream of the first portion, wherein the second portion has a continuously varying cross section and wherein the spiral focusing channel delivers the target particles to the particle manipulation device in a tighter distribution around a flow centerline compared to the initial distribution.

The particle manipulation device may be a MEMS device which separates one or more target particles from other components of a sample stream. The MEMS device may redirect the particle flow from one channel into another channel, when a signal indicates that a target particle is present. This signal may be photons from a fluorescent tag which is affixed to the target particles and excited by laser illumination in an interrogation region upstream of the MEMS device. Thus, the MEMS device may be a particle or cell sorter operating on a fluid sample confined to a microfabricated fluidic channel, but using detection means similar to a FACS flow cytometer. In particular, the U.S. patent application Ser. No. 13/998,095 (the '095 application) discloses a microfabricated fluidic valve having an inlet channel, sort channel and waste channel wherein the inlet and sort channels are formed in a plane but the waste channel is substantially orthogonal to that plane.

Accordingly, the particle manipulation stage in the '095 application may have at least one of the microfabricated fluidic channels route the flow out of the plane of fabrication of the microfabricated valve. A valve with such an architecture has the advantage that the pressure resisting the valve movement is minimized when the valve opens or closes, because the movable member is not required to move a column of fluid out of the way. Instead, the fluid containing the non-target particles may move over and under the movable member to reach the waste channel. As a result, relatively high fluid velocities may be possible using such a particle manipulation stage, and consequently, the focusing forces in the spiral focusing channel may be capable of achieving good particle focusing.

The systems and methods disclosed here also enable the construction of a cell sorting system, wherein the flow from a single input channel can be diverted into either a sort output channel, or allowed to flow through to the waste channel. The decision to sort or not may be determined using fluorescence activated cell sorting techniques. Using the spiral focusing channel, the speed and accuracy of the cell sorting system may be enhanced or improved.

These and other features and advantages are described in, or are apparent from, the following detailed description.

### BRIEF DESCRIPTION OF THE DRAWINGS

Various exemplary details are described with reference to the following figures, wherein:

FIG. 1a is a plan view of a particle manipulation system with a spiral focusing channel; FIG. 1b is a detailed view of one segment of the spiral focusing channel; FIG. 1c is a detail view of another segment of the spiral focusing channel;

FIG. 2a is a detailed view of a segment of the spiral focusing channel showing the velocity distribution within the fluid; FIG. 2b shows the movement of particles within the velocity distribution of FIG. 2a;

FIG. 3a is a detailed view of another segment of the spiral focusing channel; FIG. 3B is an illustration of the wall interaction force in the segment shown in FIG. 3A;

FIG. 4a shows the position distribution of particles within a stream at the input to the particle manipulation system; FIG. 4B shows the final distribution of particles within the fluid flow at the output of the spiral focusing channel.

FIG. 5 is a simplified plan view of a microfabricated particle sorting system in the unactuated (waste) position;

FIG. 6 is a simplified plan view of a microfabricated particle sorting system in the actuated (sort) position;

FIG. 7a is a simplified plan view of a microfabricated particle sorting system showing the field of view of the detector, with the microfluidic valve in the quiescent (no sort) position; FIG. 7b is a simplified illustration of a microfabricated particle sorting system showing the field of view of the detector, with the microfluidic valve in the actuated (sort) position;

FIG. 8 is a plan view of the microfabricated particle sorting system in combination with a hydrodynamic focusing manifold; and

FIG. 9 is a system-level illustration of a microfabricated particle sorting system according to the present invention, showing the placement of the various detection and control components.

### DETAILED DESCRIPTION

In the figures discussed below, similar reference numbers are intended to refer to similar structures or various embodiments of those structures. The structures are illustrated at various levels of detail to give a clear view of the important features of this novel device. It should be understood that these drawings do not necessarily depict the structures to scale, and that directional designations such as “top,” “bottom,” “upper,” “lower,” “left” and “right” are arbitrary, as the device may be constructed and operated in any particular orientation. In particular, it should be understood that the designations “sort” and “waste” are interchangeable, as they only refer to different populations of particles, and which population is called the “target” or “sort” population is arbitrary. The terms “micromechanical” and “microfabricated” are used interchangeably herein to denote a structure made photolithographically and with dimensions typically in the mm or sub-mm range.

In the figures and description which follow, reference number 1 refers to a microfabricated particle manipulation structure, which may include the spiral focusing channel 25 and a particle manipulation device 40. In some embodiments, the particle manipulation device 40 may be a microfabricated cell sorter 40, which may separate target particles from nontarget material. The particle manipulation structure 1 may then form a component in a larger particle manipulation system 1000, which may be a particle sorting system.

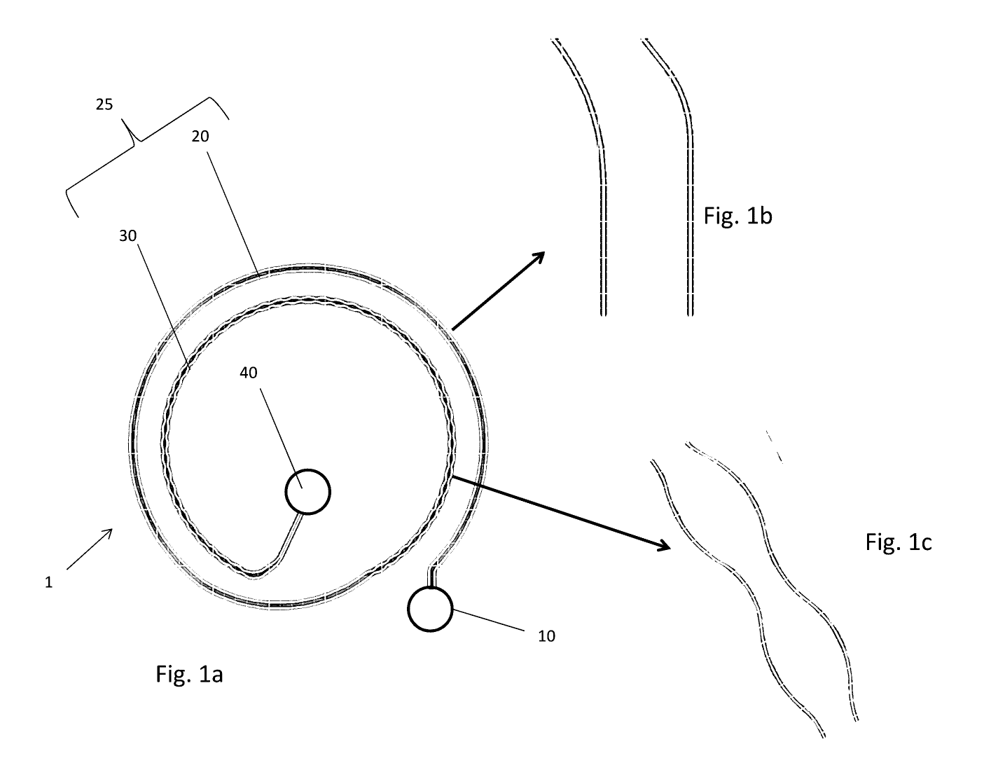

FIG. 1a is a plan view of a particle manipulation structure 1 with a spiral focusing channel 25. The particle manipulation structure 1 may include an input structure 10, a first spiral portion 20, a second spiral portion 30, and a particle manipulation device 40. The first portion 20 may curve in an arc, but with a substantially uniform cross section, as shown in FIG. 1b. In contrast, the second spiral portion 30 may follow the first portion 20 in a contiguous way, however, the second portion 30 may have a varying cross section, as described further below. A sample fluid containing target particles and non-target materials may flow from the input structure 10, through the first portion 20, the second portion 30 and to the particle manipulation device 40 under hydrostatic pressure applied to the sample fluid. The input structure 10, first portion 20, second portion 30, and particle manipulation device 40 may all be formed in the surface of a substrate using photolithographic, i.e. MEMS, techniques.

Accordingly, a micromechanical particle manipulation structure 1 is disclosed, which may include a sample fluid having target particles in an initial distribution along with non-target material, in an input channel formed on a substrate, a particle manipulation device formed on a substrate that manipulates the sample fluid flowing in the input channel, and a spiral focusing channel microfabricated in the substrate and disposed upstream of the particle manipulation device, wherein the spiral focusing channel is curved in a spiral shape having a first portion with substantially uniform cross section which focuses the particles toward a plane parallel to the substrate, and a second portion downstream of the first spiral portion, wherein the second portion has a varying cross section and wherein the spiral focusing channel delivers the target particles to the particle manipulation device in a tighter distribution around a flow centerline compared to the initial distribution. In some embodiments, the spiral focusing channel 25 may focus about 95% of the particles within a cylinder of about 10 microns diameter. More generally, the spiral focusing channel 25 may focus at least about 80% of the particles within a cylinder having a diameter of about 30% of the diameter of the channel.

The input to the particle manipulation structure 1 is input structure 10, which may simply be a fluid coupling between the microfabricated channel and a fluid reservoir, for example, wherein the fluid reservoir contains a sample fluid. In some embodiments, the sample fluid may be a suspension of biological particles, for example, suspended in a buffer fluid, such as saline or fetal bovine serum. The sample fluid may therefore include target particles as well as nontarget material. The target particles may be, for example, a stem cell, sperm cells, a cancer cell, a zygote, a protein, a T-cell, a bacteria, a component of blood, and a DNA fragment. The spiral focusing channel may be disposed in the same plane as the particle the manipulation device, and formed on the same substrate.

Under an applied hydrostatic pressure, the fluid may flow from input structure 10 through the spiral focusing channel 25, to the particle manipulation device 40. The spiral focusing channel 25 shown in FIG. 1a may comprise two portions, a first (outer) spiral portion 20 followed by a second (inner) spiral portion 30. Of course, the “inner” versus “outer” designation is arbitrary, as the flow may be reversed such that the input structure is disposed in the interior of the spiral, and the particle manipulation device 40 on the exterior of the spiral. However, in general, an upstream constant cross section portion 20 may be followed by a downstream variable cross section portion 30. The function of these two portions 20 and 30 is explained further below. The channel may be microfabricated, that is formed using photolithographic techniques, such that it may have dimensions which are in the micron, millimeter or sub millimeter range. For example, the channel may have a width on the order of 75 μm, and a depth of a similar dimension, also 50 μm. The channel dimensions may be sufficiently wide to admit larger biological particles, without impeding the flow of the buffer fluid substantially.

The first (outer) portion 20 of the spiral focusing channel 25 may be a constant cross-section channel 20 which is curved in a spiral arc with a radius of curvature of at least about 100 microns and at most about 500 microns. The total length of the spiral channel 20, shown in FIG. 1b, maybe about 25 millimeters.

The first spiral portion 20 may be followed by another microfabricated channel, second portion 30, which may have a varying cross-section as shown in FIG. 1c. The varying cross section may result from undulating sidewalls which undulate with a frequency and amplitude as discussed further below. The relative phase of the undulation between the sidewalls is about 180 degrees, i.e. the undulations are 180 degrees out of phase between one sidewall and the other. The second (inner) portion 30 may be a variable cross-section channel which is curved in a spiral arc with a radius of curvature of at least about 100 microns and at most about 500 microns. The total length of the spiral channel 20, shown in FIG. 1b, maybe about 20 millimeters. Accordingly, the variable cross sections are a sequence of progressively smaller dimensions, followed by progressively larger dimensions, followed again by progressively smaller dimensions.

The particle manipulation device 40 may be a microfabricated structure that performs some operation on a target particle or population of particles. The manipulation may be a counting (cytometry) or the application of a force, or irradiation, or the selective removal of certain particles from the flow (sorting), for example. In some embodiments, the particle manipulation device is at least one of a cell sorter and a cytometer. After the manipulation device 40, the fluid stream may exit the particle manipulation structure 1.

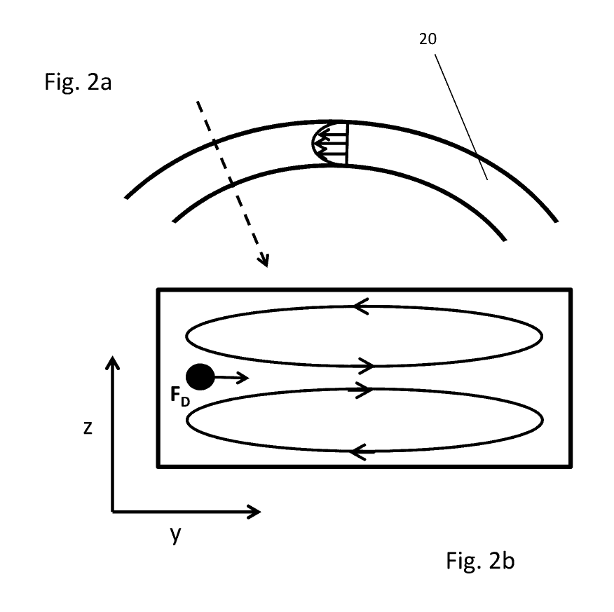

FIG. 2a shows additional detail of the first portion 20 of the spiral focusing channel 25. The first portion 20 is a substantially circular arc of at least about 180° from the input channel, and having a substantially uniform cross section throughout the arc. As is well known from fluid mechanics, any flow in a constrained channel has a velocity distribution profile as shown in FIG. 2a. The velocity distribution profile shows the boundary layer condition wherein the velocity drops to essentially zero at the channel edges, and up to a maximum at the center of the channel. Because of this velocity distribution profile, particles near the center of the channel flow with higher velocity than particles near the channel walls. Accordingly, the velocity of a particle flowing in the stream may depend on its position within the channel. This may lead to considerable uncertainty as to the timing of the manipulation to be performed on the particle by the particle manipulation device 40.

In addition, for a curved channel, centrifugal forces create a transverse flow pattern in the curved channel, which under certain circumstances manifest themselves as a pair of Dean vortices. As particles flow down the channel, they spiral around the Dean vortex cores while a combination of drag and shear-induced forces move them toward the channel center. The Dean forces therefore tend to urge the particles into a plane near the center of the z-dimension of the channel, as shown in FIG. 2b. Accordingly, the circular arc of the first portion 20 of the spiral focusing channel 25 tends to move the target particles into substantially a single plane, and that plane may be parallel to the fabrication surface of the substrate, i.e. the exposed top surface of the substrate, to which the fabrication lithography is applied.

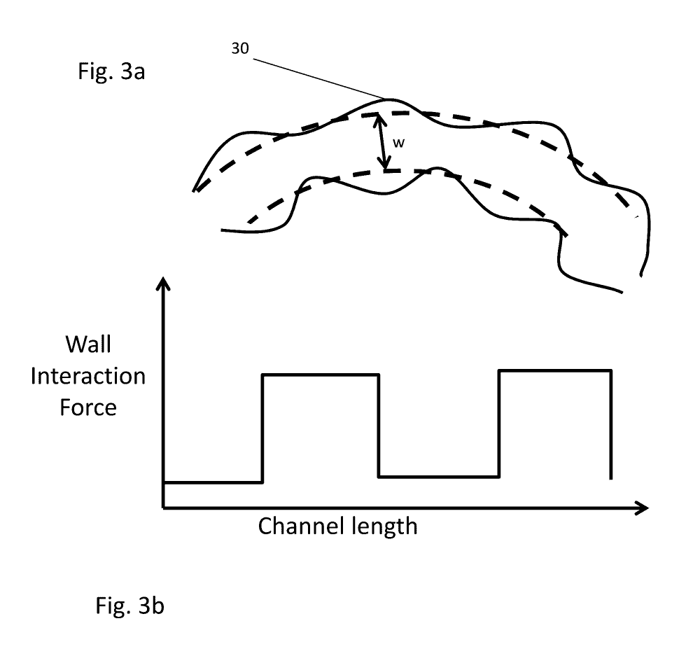

Upon exiting the first portion 20 of the spiral focusing channel 25, the fluid enters the second portion 30 with variable cross section. FIG. 3a shows a portion of the second portion 30 with variable cross section of the spiral focusing channel 25 in greater detail. As shown in FIG. 3a and discussed briefly above, the cross sectional variability of second portion 30 may result from two undulating sidewalls with which vary with a phase about 180° apart. Accordingly, the sidewalls reach a point of maximum separation, and thus maximum cross section, followed by a point of minimum separation and thus minimum cross section. As a result, the second portion 30 of the spiral focusing channel 25 may have a continuously varying cross-section which varies from about 0.5×10⁴ micronŝ2 to about 1.5×10⁴ micronŝ2. The undulation period may be about 300 μm long. Whereas the first portion 20 of the spiral focusing channel 25 shown in FIG. 1a may be about 25 mm long, the second portion 30 may be about 20 mm long. The amplitude of the undulation shown in FIGS. 1c and 3a may be about 50 microns, so that the channel width varies from about 150 microns across at its widest to about 50 microns across at its narrowest. The second portion 30 having varying cross section may have an average width w of about 110 microns. This second portion 30 of the spiral channel 25 may also curve in an arc of at least 180 degrees.

As mentioned previously, the consequence of the undulating sidewalls which are 180° out of phase is that there is a periodic increase in the wall interaction force as the particles travel down the channel. As the target particles flowing in the sample stream traverse the second portion 30 of the spiral focusing channel 25, they experience a periodic interaction with these undulating sidewalls, as shown qualitatively in FIG. 3B. The periodic presence and absence of wall interaction may cause vortices to form in the expanding region. This may cause secondary forces to arise within the flow, tending to focus the particles in the sample stream within a streamline near the center of the channel. The result of this interaction is that the particles are urged toward the center of the channel.

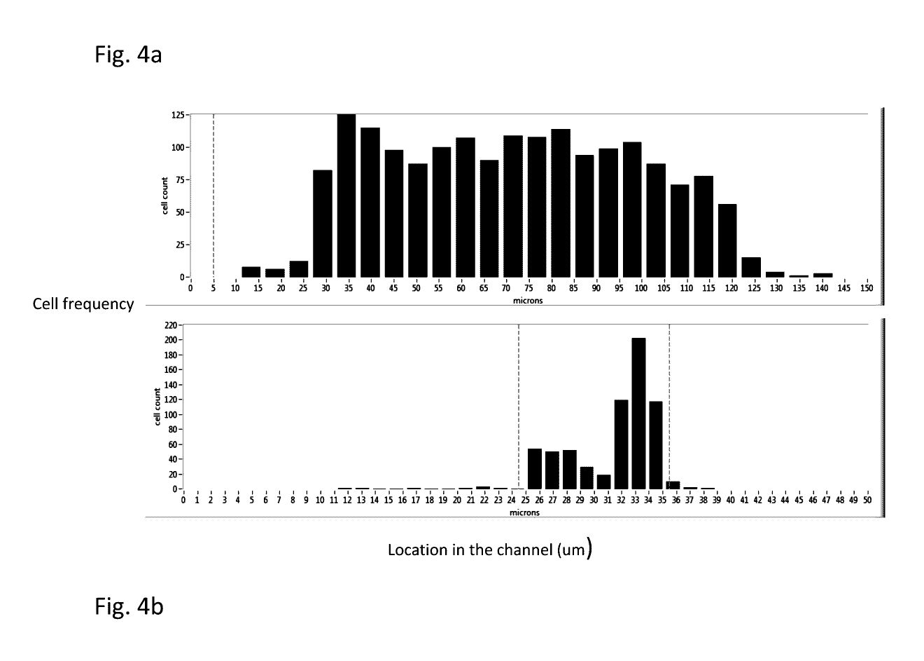

Accordingly in the first portion 20 of the spiral focusing channel 25 the target particles are urged generally into a single plane within the channel. In the second portion 30 of the spiral focusing channel 25, the target particles in the plane are then urged to the center of the cross-section of the channel. As a result of the two portions 20 and 30 of the spiral focusing channel 25, the target particles tend to be focused into a streamline which is approximately in the center of the channel both laterally and in the Z direction. this focusing aspect is shown quantitatively and FIGS. 4a and 4b, which are described next.

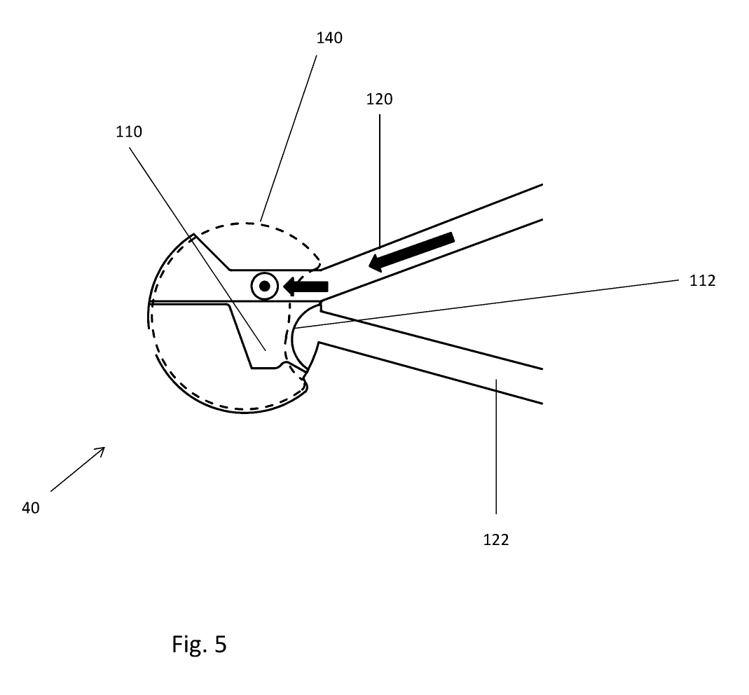

FIG. 4a shows an initial distribution of target particle location within the channel. Such a distribution may be input to the spiral focusing channel 25 by input structure 10. As shown in FIG. 4a, the distribution is broad, which is to say, that the particles may be located anywhere within a rather large fraction of the sample channel. This is not advantageous for the particle manipulation stage, because it is not known precisely where within the channel a target particle is positioned. Because of the velocity distribution profile within the channel, shown in FIG. 2a, uncertainty as to the particles' location translates into an uncertainty in the particles velocity in the fluid. As a result, the manipulation to be carried out on the particle has a large uncertainty with respect to the timing of the manipulation. For example, if the particle manipulation structure 1 has a particle sorting device 40 as shown in FIGS. 5, 6 and 7, a gate may be open too early or too late to sort the target particle properly. If the particle is moving faster than expected, the gate or valve may move too late; if the particle is moving too slowly, the gate or valve may move too soon. Accordingly, for the particle manipulation stage such as the particle sorter shown in FIGS. 5, 6 and 7, it is preferred that the target particles be located within a tight distribution near the center of the channel.

The initial distribution shown in FIG. 4a is applied to input structure 10 and then to a spiral focusing channel 25. This initial input distribution is first focused into a plane, that is, in the z-dimension as shown in FIG. 2b, after its passage through the constant cross section first portion 20 of the spiral focusing channel 25. Thereafter, the flow enters the second undulating spiral portion 30 of the spiral focusing channel 25, wherein the particles are focused in the y-dimension, and into a streamline substantially at the center of the channel at the particle sorting system 40. Thus the initial input distribution shown in FIG. 4a may be improved by the action of the spiral focusing channel 25 into a final, much more focused distribution as shown in FIG. 4b. As can be seen in FIG. 4b, the particles are focused much more tightly around the center of the channel, upon entrance to the particle manipulation device 40. Accordingly, their individual velocities also have a much tighter distribution, and the timing of downstream particle manipulations to be performed by particle manipulation device 40 may be much more precise.

As mentioned previously, the particle manipulation device 40 may be any of a variety of processes applied to the particles suspended in the sample fluid. Examples of such manipulations include separation of target particles from the sample stream (sorting). An example of a suitable microfabricated sorting device is described further below. This particle sorting mechanism may be particularly applicable to the spiral focusing channel 25 because it allows relatively high fluid velocities. As the forces exerted on the particles by the spiral focusing channel scale with the particle velocity, such a relatively high throughput device is advantageous.

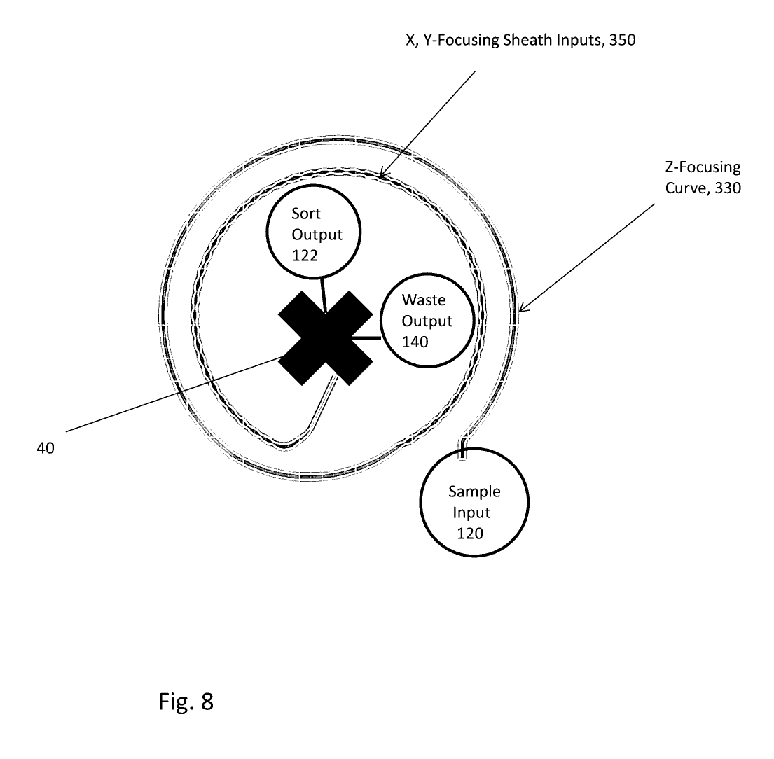

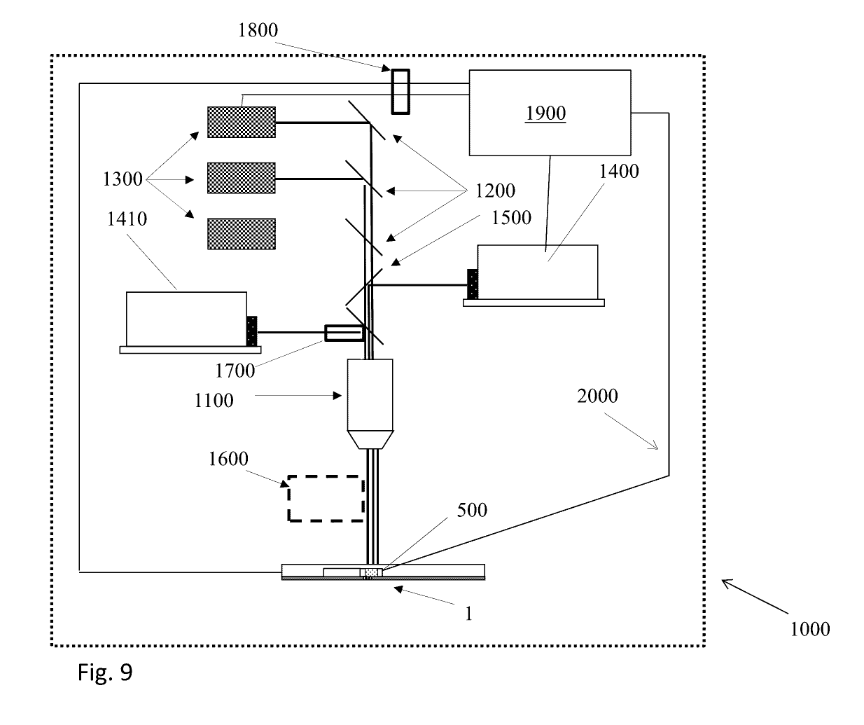

FIGS. 5 through 7 illustrate details of such a particle manipulation device 40. These details refer to an embodiment wherein the particle manipulator is a microfabricated cell sorting valve, which has unique features which may make particular use of the two portions, 20 and 30 of the spiral focusing channel 25. The particle manipulation stage described in FIGS. 5 through 7 is a movable member 110 which maybe actuated electromagnetically, within a particle manipulation system. This particle sorting device is generally referred to as reference number 40 and may be used in the particle sorting structure 1, shown generically in FIG. 8. Finally the overall particle manipulation system 1000 using the particle manipulation structure 1, and including ancillary devices is shown in FIG. 9.

FIG. 5 is an plan view illustration of the novel microfabricated particle manipulation device 40 in the quiescent (un-actuated) position. In this embodiment, the particle manipulation device is a particle sorter 40 which sorts a target particle such as a particular biological cell, from a fluid stream also containing nontarget material. The device 40 may include a microfabricated fluidic valve or movable member 110 and a number of microfabricated fluidic channels 120, 122 and 140. The fluidic valve 110 and microfabricated fluidic channels 120, 122 and 140 may be formed in a suitable substrate, such as a silicon substrate, using MEMS lithographic fabrication techniques as described in greater detail below. The fabrication substrate may have a fabrication plane in which the device is formed and in which the movable member 110 moves.

Accordingly, the spiral focusing channel is disposed in the same plane as the particle the manipulation device, and formed on the same substrate. This plane may also be parallel to the plane of motion of the particle manipulation device 40. Microfabricated particle sorting device 40, which may divert the target particles into a sort reservoir and the non-target materials into a waste reservoir when the particle manipulation device is actuated, and the motion of the particle sorting device is substantially in a plane parallel to the substrate. The particle manipulation device may be actuated by at least one of electrostatic, magnetostatic, piezoelectric, and electromagnetic forces, as will be described further below.

A sample stream may be introduced to the microfabricated fluidic valve 110 by a sample inlet channel 120. This sample inlet channel 120 may be coupled to the end of the final, second spiral portion 30 of the spiral focusing channel 25. The sample stream may contain a mixture of particles, including at least one desired, target particle and a number of other undesired, non-target particles. The particles may be suspended in a fluid and focused toward the central portion of the flow in the channel as previously described. For example, the target particle may be a biological material such as a stem cell, a cancer cell, a zygote, a protein, a T-cell, a bacteria, a component of blood, a DNA fragment, for example, suspended in a buffer fluid such as saline. The inlet channel 120 may be formed in the same fabrication plane as the valve 110, such that the flow of the fluid is substantially in that plane. The motion of the valve 110 is also within this fabrication plane.

The decision to sort/save or dispose/waste a given particle may be based on any number of distinguishing signals. In one exemplary embodiment, the decision is based on a fluorescence signal emitted by the particle, based on a fluorescent tag affixed to the particle and excited by an illuminating laser. Details as to this detection mechanism are well known in the literature, and further discussed below with respect to FIG. 9. However, other sorts of distinguishing signals may be anticipated, including scattered light or side scattered light which may be based on the morphology of a particle, or any number of mechanical, chemical, electric or magnetic effects that can identify a particle as being either a target particle, and thus sorted or saved, or an nontarget particle and thus rejected or otherwise disposed of.

With the valve 110 in the position shown, the input stream may pass unimpeded to an output orifice and channel 140 which is out of the plane of the inlet channel 120, and thus out of the fabrication plane of the device 10. That is, the flow may be from the inlet channel 120 to the output orifice 140, from which it flows substantially vertically, and thus orthogonally to the inlet channel 120. This output orifice 140 may lead to an out-of-plane channel that may be perpendicular to the plane of the paper showing FIG. 5. More generally, the output channel 140 is not parallel to the plane of the inlet channel 120 or sort channel 122, or the fabrication plane of the movable member 110.

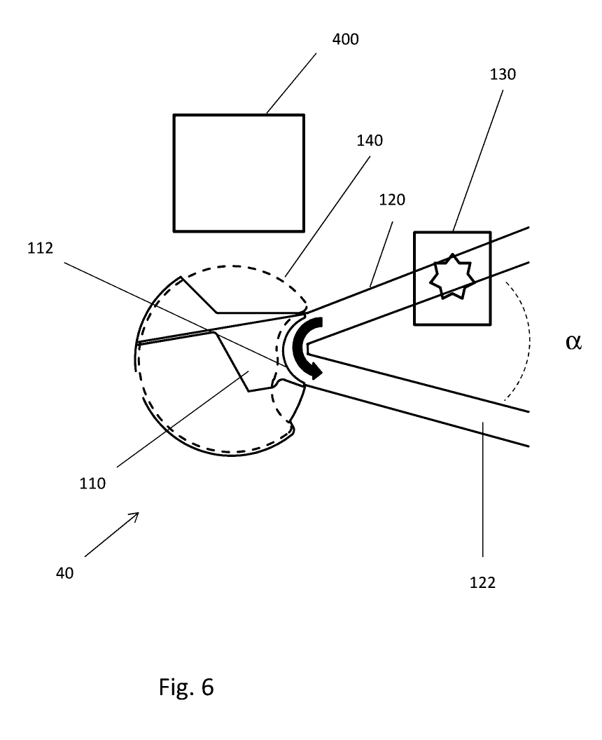

The output orifice 140 may be a hole formed in the fabrication substrate, or in a covering substrate that is bonded to the fabrication substrate. A relieved area above and below the sorting valve or movable member 110 allows fluid to flow above and below the movable member 110 to output orifice 140. Further, the valve 110 may have a curved diverting surface 112 which can redirect the flow of the input stream into a sort output stream, as described next with respect to FIG. 6. The contour of the orifice 140 may be such that it overlaps some, but not all, of the inlet channel 120 and sort channel 122. By having the contour 140 overlap the inlet channel, and with relieved areas described above, a route exists for the input stream to flow directly into the waste orifice 140 when the movable member or valve 110 is in the un-actuated waste position.

FIG. 6 is a plan view of the microfabricated device 40 in the actuated position. In this position, the movable member or valve 110 is deflected counterclockwise into the position shown in FIG. 6. The diverting surface 112 is a sorting contour which redirects the flow of the inlet channel 120 into the sort output channel 122. The output or sort channel 122 may lie in substantially the same plane as the inlet channel 120, such that the flow within the sort channel 122 is also in substantially the same plane as the flow within the inlet channel 120.

There may be an angle α between the inlet channel 120 and the sort channel 122. This angle may be any value up to about 90 degrees. Actuation of movable member 110 may arise from a force from force-generating apparatus 400, shown generically in FIG. 6. In some embodiments, force-generating apparatus may be an electromagnet, however, it should be understood that force-generating apparatus may also be electrostatic, piezoelectric, or some other means to exert a force on movable member 110, causing it to move from a first position (FIG. 5) to a second position (FIG. 6).

In one embodiment, the moveable member 110 may also include a quantity of inlaid magnetically permeable material, such as nickel-iron permalloy, inlaid into the movable member 110. This permeable material may interact with the flux produced by a separate, external electromagnet 400, which may be a permeable core wound with a current-carrying conductor. This electromagnet is shown generically as an embodiment of the force-generating apparatus, or reference number 400 in FIG. 6.

FIG. 6 also shows the positioning of a laser interrogation region 130. The laser interrogation region may be disposed upstream of the particle manipulation device 40, in the inlet channel 120. In this region, laser irradiation impinges upon passing particles, such as biological cells, which have been tagged with a fluorescent marker. Upon irradiation, the tag may fluoresce, indicating the presence of the target particle having the tag affixed to its surface. This fluorescence is gathered by detection optics and sent to a detector coupled to a computer. Based on the presence of the fluorescent signal, the computer may make a decision to sort, or save, the target particle. Therefore, the computer may send a signal to a waveform generating device, which generates a waveform for controlling the electromagnet 400. This waveform causes the electromagnet to interact with the permeable material, drawing the movable member upward and into the sort position. Although only a single laser interrogation region 130 is shown in FIG. 6, it should be understood that multiple laser interrogation regions may exist, such as another on the sort channel 122 to confirm the identity of the particles in the sort channel as being target particles.

In one embodiment, the diverting surface 112 may be nearly tangent to the input flow direction as well as the sort output flow direction, and the slope may vary smoothly between these tangent lines. In this embodiment, the moving mass of the stream has a momentum which is smoothly shifted from the input direction to the output direction, and thus if the target particles are biological cells, a minimum of force is delivered to the particles. As shown in FIGS. 5 and 6, the micromechanical particle manipulation device 40 has a first diverting surface 112 with a smoothly curved shape, wherein the surface which is substantially tangent to the direction of flow in the sample inlet channel at one point on the shape and substantially tangent to the direction of flow of a first output channel at a second point on the shape, wherein the first diverting surface 112 diverts flow from the sample inlet channel 120 into the first output channel 140 when the movable member 110 is in the first position, FIG. 5, and allows the flow into a second output channel 122 in the second position, FIG. 6.

In other embodiments, the overall shape of the diverter 112 may be circular, triangular, trapezoidal, parabolic, or v-shaped for example, but the diverter serves in all cases to direct the flow from the inlet channel to another channel.

It should be understood that although channel 122 is referred to as the “sort channel” and orifice 140 is referred to as the “waste orifice”, these terms can be interchanged such that the sort stream is directed into the waste orifice 140 and the waste stream is directed into channel 122, without any loss of generality. Similarly, the “inlet channel” 120 and “sort channel” 122 may be reversed. The terms used to designate the three channels are arbitrary, but the inlet stream may be diverted by the valve 110 into either of two separate directions, at least one of which does not lie in the same plane as the other two. The term “substantially” when used in reference to an angular direction, i.e. substantially tangent or substantially vertical, should be understood to mean within 15 degrees of the referenced direction. For example, “substantially orthogonal” to a line should be understood to mean from about 75 degrees to about 105 degrees from the line.

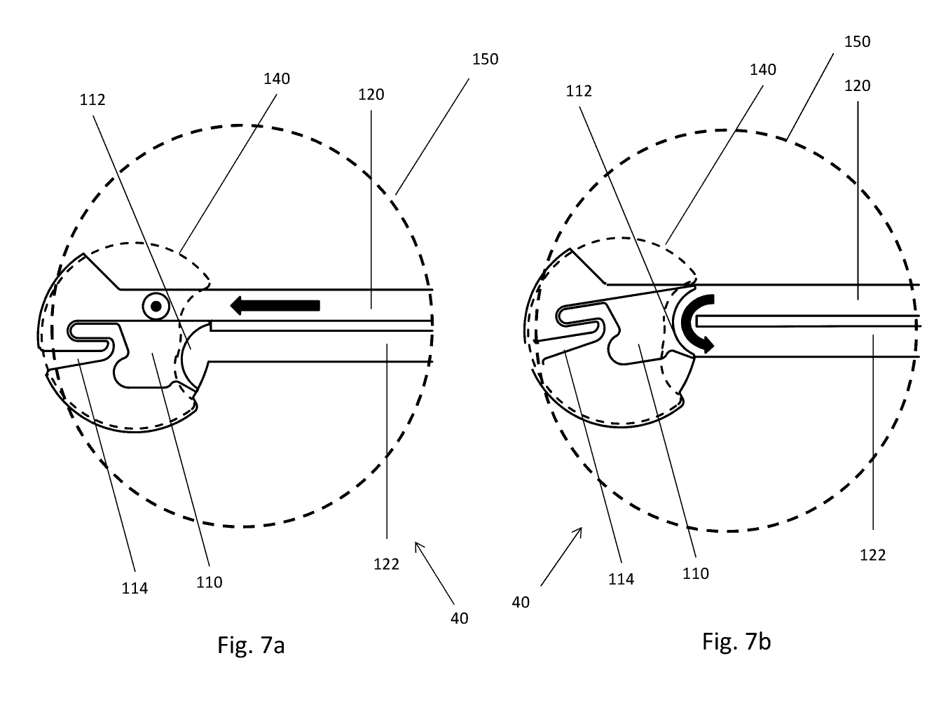

FIGS. 7a and 7b illustrate an embodiment wherein the angle α between the inlet channel 120 and the sort channel 122 is approximately zero degrees. Accordingly, the sort channel 122 is essentially antiparallel to the inlet channel 120, such that the flow is from right to left in the inlet channel 120. With valve 110 in the un-actuated, quiescent position shown in FIG. 5, the inlet stream flows straight to the waste orifice 140 and vertically out of the device 40. As mentioned previously, the inlet channel 120 may be fluidically coupled to the spiral focusing channel 25.

In FIG. 7b, the valve 110 is in the actuated, sort position. In this position, the flow is turned around by the diverting surface 112 of the valve 110 and into the antiparallel sort channel 122. This configuration may have an advantage in that the field of view of the detector 150 covers both the inlet channel 120 and the sort channel 122. Thus a single set of detection optics may be used to detect the passage of a target particle through the respective channels. It may also be advantageous to minimize the distance between the laser interrogation region and the valve 110, in order to minimize the timing uncertainty in the opening and closing of the valve.

The movable member or valve 110 may be attached to the substrate with a flexible spring 114. The spring may be a narrow isthmus of substrate material, forming a hinge. Accordingly, the particle manipulation device may have a hinge mounted movable member, which directs the target particles into a sort channel and the non-target material into a waste channel, wherein the sort channel is disposed in the plane of the substrate and the waste channel is disposed substantially orthogonally to the plane of the substrate. In the example set forth above, the substrate material may be single crystal silicon, which is known for its outstanding mechanical properties, such as its strength, low residual stress and resistance to creep. With proper doping, the material can also be made to be sufficiently conductive so as to avoid charge build up on any portion of the device, which might otherwise interfere with its movement. The spring may have a serpentine shape as shown, having a width of about 1 micron to about 10 microns and a spring constant of between about 10 N/m and 100 N/m, and preferably about 40 N/m.

The microfabricated cell sorting device 40 may be implemented in the microfabricated particle manipulation structure 1 as shown generically in FIG. 8. The input channel 120 may be contiguous with the first and second spiral portions, 20 and 30 of the spiral focusing channel 25. The spiral focusing channel 25 may concentrate or focus the particles in the interior of the flow, near the middle of the input channel. The microfabricated cell sorting device 40 may then sort the target particles into a sort output 122 and the nontarget material into the waste output 140.

The microfabricated particle manipulation structure 1 may be used in a particle sorting system 1000 enclosed in a housing containing the components shown in FIG. 9. The MEMS particle manipulation structure 1 may include the spiral focusing channel 25 to help focus the particles in the middle of the channel. The MEMS particle manipulation structure 1 may also be enclosed in a plastic, disposable cartridge which is inserted into the system 1000. The insertion area may be a movable stage with mechanisms available for fine positioning of the particle manipulation structure 1 and associated microfluidic channels against one or more reference surfaces, which orient and position the detection region and particle manipulation structure 1 with respect to the collection optics 1100. If finer positioning is required, the inlet stage may also be a translation stage, which adjusts the positioning based on observation of the location of the movable member 110 relative to a reference surface.

It should be understood that although FIG. 9 shows a particle sorting system 1000 which uses a plurality of laser sources 1400 and 1410, only a single laser may be required depending on the application. For the plurality of lasers shown in FIG. 9, one of the laser sources 1410 may be used with an associated set of parallel optics (not shown in FIG. 9) to illuminate the at least one additional laser interrogation region. This setup may be somewhat more complicated and expensive to arrange than a single laser system, but may have advantages in that the optical and detection paths may be separated for the different laser interrogation regions. Although not shown explicitly in FIG. 9, it should be understood that the detection path for additional laser(s) 1410 may also be separate from the detection path for laser 1400. Accordingly, some embodiments of the particle sorting system may include a plurality of laser sources and a plurality of optical detection paths, whereas other embodiments may only use a single laser source 1400 and collection optics 1100. In the embodiment described here, a plurality of excitation lasers uses a common optical path, and the optical signals are separated electronically by the system shown in FIG. 9.

The embodiment shown in FIG. 9 is based on a FACS-type detection mechanism, wherein one or more lasers 1400, 1410 excites one or more fluorescent tags affixed to the target particles. The laser excitation may take place in one or more interrogation regions. The fluorescence emitted as a result is detected and the signal is fed to a computer 1900. The computer then generates a control signal that controls the electromagnet 500, or multiple electromagnets if multiple sorters are used. It should be understood that other detection mechanisms may be used instead, including electrical, mechanical, chemical, or other effects that can distinguish target particles from non-target particles.

Accordingly, the MEMS particle sorting system 1000 shown in FIG. 9 may include a number of elements that may be helpful in implementing additional functionality or enhancing detection. For example, optical manipulating means 1600 may include a beamsplitter and/or acousto-optic modulator. The beam splitter may separate a portion of the incoming laser beam into a secondary branch or arm, where this secondary branch or arm passes through the modulator which modulates the amplitude of the secondary beam at a high frequency. The modulation frequency may be, for example, about 2 MHz or higher. This excitation will then produce a corresponding fluorescent pattern from an appropriately tagged cell.

This modulated fluorescent pattern may then be picked up by the detection optics 1600, which may recombine the detected fluorescence from the interrogation region. The combined radiation may then impinge on the one or more detectors 1300.

Electronic distinguishing means may be used to separate the signals from detectors 1300. The details of electronic distinguishing means 1800 may depend on the choice for optical manipulation means 1600. For example, the distinguishing means 1800 may include a high pass stage and a low pass stage that is consistent with a photoacoustic modulator that was included in optical manipulating means 1600. Or electronic distinguishing means 1800 may include a filter (high pass and/or low pass) and /or an envelope detector, for example.

Therefore, depending on the choice of detection optics 1600, the unfiltered signal output from detectors 1300 may include a continuous wave, low frequency portion and a modulated, high frequency portion. After filtering through the high pass filter stage, the signal may have substantially only the high frequency portion, and after the low pass stage, only the low frequency portion. These signals may then be easily separated in the logic circuits of computer 1900. Alternatively, the high pass filter may be an envelope detector, which puts out a signal corresponding to the envelop of the amplitudes of the high frequency pulses.

Other sorts of components may be included in electronic distinguishing means 1800 to separate the signals. These components may include, for example, a signal filter, mixer, phase locked loop, multiplexer, trigger, or any other similar device that can separate or distinguish the signals. Component 1800 may also include the high pass and/or low pass electronic filter or the envelope detector described previously. The two sets of signals from the electronic distinguishing means 1800 may be handled differently by the logic circuits 1900 in order to separate the signals.

Thus, a MEMS particle sorting system 1000 may be used in conjunction with one or more laser interrogation means, wherein the additional laser interrogation means are used to confirm the effectiveness or accuracy of a manipulation stage in manipulating a stream of particles. The measurements may then be used to adjust the sorting parameters, is via the control signal waveform 2000 delivered to the electromagnet 500. This waveform 2000 may be fine-tuned to adjust the sorting performance of the valve or movable member 110, and may be produced by logic circuits 1900. Elements 1200 may be turning minors, used to direct the fluorescence into one or more detectors 1300, and turning mirror 1500 may direct the laser light to the interrogation region.

Accordingly, a particle manipulation system may include the micromechanical particle manipulation structure previously described, at least one laser directed to a laser interrogation region disposed in the input channel, and at least one set of detection optics that detects a fluorescent signal from a fluorescent tag affixed to the target particle in the fluid. The particle manipulation system may further include an electromagnet and a circuit that provides a control waveform to the electromagnet.

The micromechanical particle manipulation structure 1 may be fabricated using thin film lithographic techniques applied to a silicon substrate, as described more fully in the '095 application. The movable portion 110 may be formed from the substrate material itself, and rendered moveable by releasing it from the rest of the substrate except for a thin isthmus, or hinge, of substrate material. In one embodiment, the movable feature 110 may be formed from the device layer of a silicon-on-insulator (SOI) substrate, and released by removing the underlying dielectric layer. Alternatively, the structure 1 may be fabricated using substrates formed of metals, semiconductors (silicon, e.g.) polymers, glasses, metals, and the like. The spiral focusing channel may also be micro-molded or 3D printed.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. Accordingly, the exemplary implementations set forth above, are intended to be illustrative, not limiting.

What is claimed is:

1. A micromechanical particle manipulation structure, comprising:
a sample fluid having target particles in an initial distribution along with non-target material, in an input channel formed on a substrate;
a particle manipulation device formed on a substrate that manipulates the sample fluid flowing in the input channel;
a spiral focusing channel microfabricated in the substrate and disposed upstream of the particle manipulation device, wherein the spiral focusing channel is curved in a spiral shape having a first portion with substantially uniform cross section which focuses the particles toward a plane parallel to the substrate, and a second portion downstream of the first portion, wherein the second portion has a continuously varying cross section and wherein the spiral focusing channel delivers the target particles to the particle manipulation device in a tighter distribution around a flow centerline compared to the initial distribution.

2. The micromechanical particle manipulation structure of claim 1, wherein the second portion of varying cross section results from undulating sidewalls which vary with a phase 180 degrees apart between the undulating sidewalls.

3. The micromechanical particle manipulation structure of claim 1, wherein the second portion of varying cross section varies from about 0.5×10⁴ micronŝ2 to about 1.5×10⁴ micronŝ2.

4. The micromechanical particle manipulation structure of claim 2, wherein a period of undulation is about 300 microns.

5. The micromechanical particle manipulation structure of claim 1, wherein the first portion of the spiral focusing channel is about 25 millimeters long, and the second portion is about 20 millimeters long.

6. The micromechanical particle manipulation structure of claim 2, wherein the second portion of varying cross sections wherein an amplitude of undulation is about 50 [PLEASE CONFIRM] microns.

7. The micromechanical particle manipulation structure of claim 1, wherein the first portion of the spiral focusing channel curves in an arc of at least about 180 degree from the input channel, and focuses the target particles toward the plane parallel to the substrate.

8. The micromechanical particle manipulation structure of claim 1, wherein the first portion and second portion of the spiral focusing channel has a radius of curvature of at least about 100 microns and less than about 500 microns.

9. The micromechanical particle manipulation structure of claim 1, wherein the spiral focusing channel focuses 80% of the particles within a cylinder having a diameter of about 30% of the diameter of the channel.

10. The micromechanical particle manipulation structure of claim 1, wherein the second portion of varying cross section has an average width of about 110 microns.

11. The micromechanical particle manipulation structure of claim 1, wherein the spiral focusing channel is disposed in the same plane as the particle the manipulation device, and formed on the same substrate.

12. The micromechanical particle manipulation structure of claim 1, wherein the target particles are at least one of a stem cell, a cancer cell, a zygote, a protein, a T-cell, a bacteria, a component of blood, and a DNA fragment.

13. The micromechanical particle manipulation structure of claim 1, wherein the particle manipulation device is at least one of a cell sorter and a cytometer.

14. The micromechanical particle manipulation structure of claim 1, wherein the particle manipulation device is a microfabricated particle sorting device, which diverts the target particles into a sort reservoir and the non-target materials into a waste reservoir when a particle manipulation device is actuated, and a motion of the particle sorting device is substantially in a plane parallel to the substrate.

15. The micromechanical particle manipulation structure of claim 14, wherein the particle manipulation device is actuated by at least one of electrostatic, magnetostatic, piezoelectric, and electromagnetic forces.

16. The micromechanical particle manipulation structure of claim 14, wherein the particle manipulation device has a hinge mounted movable member, which directs the target particles into a sort channel and the non-target material into a waste channel, wherein the sort channel is disposed in the plane of the substrate and the waste channel is disposed substantially orthogonally to the plane of the substrate.

17. The micromechanical particle manipulation structure of claim 14, wherein the cell sorter is a particle manipulation device which further comprises:
a first permeable magnetic material inlaid in the movable member;
a first stationary permeable magnetic feature disposed on the substrate; and
a first source of magnetic flux external to the movable member and substrate on which the movable member is formed.

18. A particle manipulation system, comprising:
the micromechanical particle manipulation structure of claim 1;
at least one laser directed to a laser interrogation region disposed in the input channel; and
at least one set of detection optics that detects a fluorescent signal from a fluorescent tag affixed to the target particle in the fluid.

19. The micromechanical particle manipulation system of claim 15, further comprising:
an electromagnet; and
a circuit that provides a control waveform to the electromagnet.

20. The particle manipulation system of claim 18, wherein the particle manipulation device is enclosed in a disposable cartridge.
